(19) United States
(12) Patent Application Publication
(10) Pub. No.: US 2013/0136294 A1
(43) Pub. Date: May 30, 2013

(54) EARPHONES

(71) Applicants: Noel Lee, Las Vegas, NV (US); Jacky Hsiung, San Jose, CA (US)

(72) Inventors: Noel Lee, Las Vegas, NV (US); Jacky Hsiung, San Jose, CA (US)

(73) Assignee: Monster Cable Products, Inc., Brisbane, CA (US)

(21) Appl. No.: 13/599,607

(22) Filed: Aug. 30, 2012

Related U.S. Application Data
(60) Provisional application No. 61/530,364, filed on Sep. 1, 2011.

(51) Int. Cl. H04R 1/10

(52) U.S. Cl. CPC H04R 1/10
USPC 381/380

(57) ABSTRACT

An earphone having an acoustically transparent passage with a moveable cover for controlling the amount of ambient sound transmitted to a listener's ear canal. In the fully closed position, the cover prevents or restricts ambient sound from reaching the listener's ear canal. In an open position the cover allows entry of the ambient sound into the listener's ear canal, increasing the listener's safety during situations requiring awareness of external sounds, and allows participation in conversations and the like. Optionally, the cover exposes or hides and indicator to the onlooker when it is moved, allowing the onlooker to see the state of the device.

### CROSS-REFERENCE TO RELATED APPLICATIONS

The present application claims the priority of U.S. Provisional Patent Application Ser. No. 61/530,364, entitled “Headphones”, filed Sep. 1, 2011, which application is incorporated in its entirety herein by reference.

### TECHNICAL FIELD

The present invention is generally related to earphones, and more particularly is related to in-ear or on-ear earphones which allow a wearer to selectively control blocking ambient sound.

### BACKGROUND ART

Earphones by design usually block out most or all ambient noise. When wearing in-ear or on-ear earphones, the listener is typically faced with the choice of only being able to hear what is being played through the earphones, or removing them to hear ambient sounds. In fact, that aspect is often touted as a feature in marketing these products, promoting the fidelity of the sound produced by the earphones with very little sound pollution allowed into the listener's ear. However, this condition can create danger or inconvenience to the listener when the listener wants to, or needs to, hear ambient sounds. In such cases, the listener is often faced with the choice of removing one or both earphones, which reduces or eliminates any utility of wearing earphones at all.

### BRIEF SUMMARY OF THE INVENTION

The present invention addresses the above and other needs by providing an earphone which includes an earphone housing allowing a listener to adjust the entry of ambient sound into the listener's ear canal. The earphone housing includes a sliding cover over an opening to an acoustical passage which carries ambient sound through the earphone housing to the listener's ear canal. Closing the sliding cover prevents or reduces the entry of the ambient sound into the listener's ear canals. Opening the sliding cover allows the entry of the ambient sound into the listener's ear canals, increasing the listener's safety during situations requiring awareness of external sounds, and allows participation in conversations and the like.

In accordance with one aspect of the invention, there is provided an earphone including an indicator visible to an onlooker and showing whether the earphone is in an open position allowing ambient sound to reach the listener, or in a closed position preventing or limiting ambient sound reaching the listener for signaling to the onlooker the state of the device.

### BRIEF DESCRIPTION OF THE DRAWINGS

The above and other aspects, features and advantages of the present invention will be more apparent from the following more particular description thereof, presented in conjunction with the following drawings wherein:

FIG. 1A is a front view of an earphone according to the present invention, showing an acoustical passage cover in a closed position.

FIG. 1B is an end view of the earphone according to the present invention, showing the acoustical passage cover in the closed position.

FIG. 1C is a rear view of the earphone according to the present invention, showing the acoustical passage cover in the closed position.

FIG. 2A is a cross-sectional view of the earphone according to the present invention, showing the acoustical passage cover in the closed position, taken along line 2-2 of FIG. 1B.

FIG. 2B is a cross-sectional view of the earphone according to the present invention, showing the acoustical passage cover in an open position, taken along line 2-2 of FIG. 1B,

FIG. 3 is a front view of the earphone according to the present invention, showing the acoustical passage cover in the open position.

FIG. 4A shows an embodiment of the earphone with a rotatable cover in a closed position.

FIG. 4B shows the earphone with the rotatable cover in an open position.

Corresponding reference characters indicate corresponding components throughout the several views of the drawings.

### BEST MODES FOR CARRYING OUT THE INVENTION

The following description is of the best mode presently contemplated for carrying out the invention. This description is not to be taken in a limiting sense, but is made merely for the purpose of describing one or more preferred embodiments of the invention. The scope of the invention should be determined with reference to the claims.

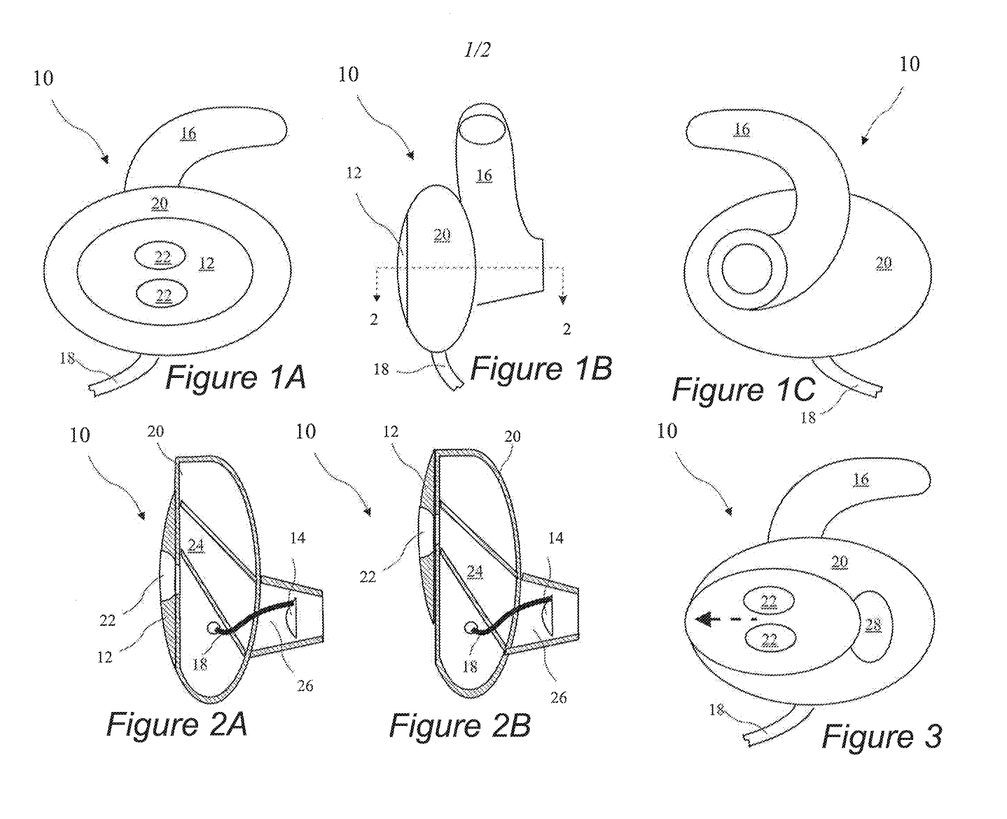

A front view of an earphone 10 according to the present invention, showing a housing 20 with an acoustical passage cover 12 in a closed position, is shown in FIG. 1A, an end view of the earphone 10 showing the acoustical passage cover 12 in the closed position is shown in FIG. 1B, a rear view of the earphone 10 showing the acoustical passage cover 12 in the closed position is shown in FIG. 1C, and a cross-sectional view of the earphone 10 showing the acoustical passage cover 12 in the closed position, taken along line 2-2 of FIG. 1B, is shown in FIG. 2A. When the cover 12 is in the closed position, solid portions of the cover 12 cover an acoustic pathway 24 which leads to the speaker passage 26 containing a speaker 14, restricting the passage of ambient sound to the listener thus providing a better listening experience for the listener. The closed position improves the audio quality of sound provided by the speaker 14 by restricting the sound provided to the listener to sound created by the speaker 14. The earphone 10 generally receives electronic signals provided through the wire/cable 18 plugged into a personal audio device (e.g. record player, CD player, MP3 player, Ipod, etc.).

The earphone 10 can be worn by the listener in a variety of ways including using an in-ear hook 16, or over-ear hook (not shown), ear-buds (not shown), or larger on-ear or over-ear earphones (not shown), and an earphone according to the present invention with any listener attachment is intended to come within the scope of the present invention.

A cross-sectional view of the earphone 10 showing the acoustical passage cover 12 in an open position, taken along line 2-2 of FIG. 1B, is shown in FIG. 2B and a front view of the earphone 10, showing the acoustical passage cover 12 in the open position, is shown in FIG. 3. In the open position, ambient sound is allowed to enter the acoustic passage 24 and be heard by the listener. The cover 12 includes vents (or holes) 22 which allow ambient sounds to enter the earphone 10 when the cover 12 is in the open position. The vents 22 may be open, or may be covered by an acoustically transparent material, allowing sound to pass unimpeded. The open position allows hearing sirens, other warnings, and the like.

In the open position, ambient sound may pass around the speaker 14 in the speaker passage 26, or the speaker 14 may fill the speaker passage 26 and the ambient sound may pass through the speaker 14, for example, through the speaker cone of the speaker 14. Alternatively, the speaker passage may be split into two passages, the speaker 14 in one passage and the ambient sound enter through the other passage.

In one embodiment the earphone 10 is opened and closed by sliding the acoustical passage cover 12 to align the vents 22 with the acoustic passages 24. In another embodiment the acoustical passage cover may be rotated to the opened or closed position.

The earphone 10 may include an indicator 28, which is an area of the earphone housing which is exposed when the cover 12 is in the open position and concealed when the cover 12 is in the closed position. The indicator 28 preferably comprises a color different from the color of the cover or the other parts of the earphone 10. For example, if the earphone is generally white, a red indicator area 28 would allow the listener to easily determine if the earphone is in the high fidelity (cover closed position) or the safety position (cover open position) by exposing the red indicator 28.

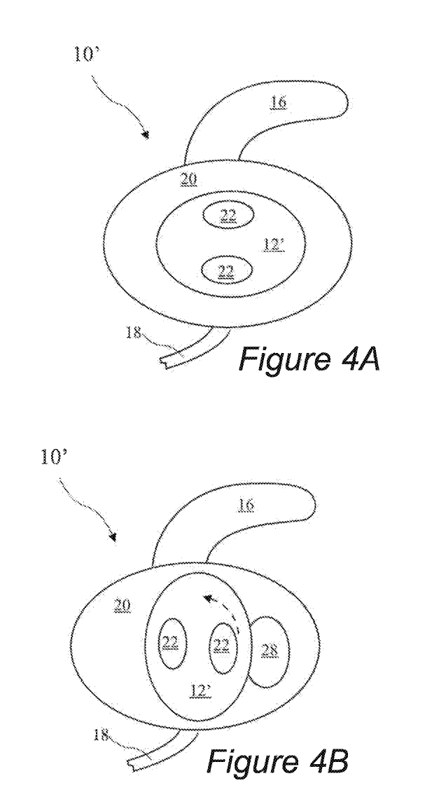

An embodiment of the earphone 10 with a rotatable cover 12 in a closed position is shown in FIG. 4A and an embodiment of the earphone 10 with the rotatable cover 12 in an open position is shown in FIG. 4B.

While the invention herein disclosed has been described by means of specific embodiments and applications thereof, numerous modifications and variations could be made thereto by those skilled in the art without departing from the scope of the invention set forth in the claims.

We claim:

1. An earphone comprising:
a housing;
a speaker passage disposed on a listener side of the housing and configured for acoustic communication with a listener;
a speaker disposed in the speaker passage configured for providing sound to the listener;
an acoustic passage passing through the housing and in acoustic communication with the speaker passage;
a cover movable to an open position and to a closed position; and
an acoustically transparent vent in the cover, the vent being alignable with the acoustic passage when the cover is in the open position for allowing ambient sound to reach the speaker passage, the vent being offset from the acoustic passage when the cover is in the closed position for restricting ambient sound from reaching the speaker passage.

2. The earphone of claim 1, wherein the cover is a slidable cover.

3. The earphone of claim 1, wherein the cover is a rotatable cover.

4. The earphone of claim 1, wherein the cover is located on the housing opposite the speaker passage.

5. The earphone of claim 1, wherein an indicator is displayed when the cover is in the open position and the indicator is concealed when the cover is in the closed position.

6. The earphone of claim 1, wherein an indicator is displayed when the cover is in the closed position and the indicator is concealed when the cover is in the open position.

7. The earphone of claim 1, wherein the earphone is held to a listener's ear by an in-the-ear hook.

8. An earphone comprising:
a housing;
a speaker passage disposed on a listener side of the housing and configured for acoustic communication with a listener;
a speaker disposed in the speaker passage and configured for providing sound to the listener;
an acoustic passage passing through the housing and in acoustic communication with the speaker passage; and
a sliding cover residing on a side of the housing opposite to the speaker passage and movable to an open position and to a closed position, the cover including an acoustically transparent vent being alignable with the acoustic passage when the cover is in the fully opened position for allowing ambient sound to reach the speaker passage, and completely offset from the acoustic passage when the cover is in the fully closed position for restricting ambient sound from reaching the speaker passage.

9. An earphone comprising:
a housing;
a speaker passage disposed on a listener side of the housing and configured for acoustic communication with a listener;
a speaker disposed in the speaker passage and configured for providing sound to the listener;
an acoustic passage passing through the housing and in acoustic communication with the speaker passage;
a sliding cover residing on a side of the housing opposite to the speaker passage and movable to an open position and to a closed position, the cover including an acoustically transparent vent being alignable with the acoustic passage when the cover is in the fully opened position for allowing ambient sound to reach the speaker passage, and completely offset from the acoustic passage when the cover is in the fully closed position for restricting ambient sound from reaching the speaker passage; and
an indicator on the housing, the indicator being exposed when the cover is not in the fully closed position, and the indicator being concealed when the cover is in the fully closed position showing that the listener may not hear warning sounds.

10. A method for controlling passage of ambient noise through an earphone to a listener, the method comprising:
positioning an earphone over a listener's ear o provide sound to the listener;
aligning a speaker passage of the earphone with the listener's rear canal;
positioning a moving cover, attached to a housing of the earphone opposite the speaker passage, to block an acoustic passage through the housing of the earphone to reduce a communication of ambient noise to the listener's ear canal; and
moving the moving cover to align at least one vent in the moving cover with the acoustic passage to facilitate the communication of ambient noise to the listener's ear canal.

11. The method of claim 10, wherein positioning the moving cover comprises sliding the moving cover.

12. The method of claim 10 wherein positioning the moving cover comprises rotating the moving cover.

13. The method of claim 10, further including covering and uncovering an indicator when the cover is moved.
